(19) United States
(12) Patent Application Publication
(10) Pub. No.: US 2026/0050349 A1
(43) Pub. Date: Feb. 19, 2026

(54) Operating Panel

(71) Applicant: Marelli Corporation, Saitama-city, Saitama (JP)

(72) Inventors: Mei Setsu, Saitama-city, Saitama (JP); Daisuke Kondou, Saitama-city, Saitama (JP); Ryou Murakami, Saitama-city, Saitama (JP); Natsuki Okabe, Saitama-city, Saitama (JP); Yuuma Tasai, Saitama-city, Saitama (JP)

(21) Appl. No.: 19/102,111

(22) PCT Filed: Jun. 21, 2023
(86) PCT No.: PCT/JP2023/022945

§ 371 Date: Feb. 7, 2025

(30) Foreign Application Priority Data
Aug. 10, 2022 (JP) 2022-127663

(51) Int. Cl. G06F 3/044

(52) U.S. Cl. CPC G06F 3/044

(57) ABSTRACT

An operating panel includes: a panel member; a switch unit provided on the panel member and configured to be pressed by a user; a sensor unit configured to detect a capacitance that changes according to a positional relationship between a finger of the user and the switch unit; and a control unit configured to receive the capacitance detected by the sensor unit, and the control unit determines a contact starting point at which the finger of the user comes into contact with the switch unit based on an inflection point appearing in a change waveform of the received capacitance, and determines, when the capacitance further increases from the contact starting point and exceeds a predetermined value, an operation state in which the switch unit is being operated.

### TECHNICAL FIELD

The present invention relates to an operating panel.

### BACKGROUND ART

Non Patent Document (Kawai Satoru, Kobayashi Hisayuki, Nakamura Hideo, “Change in skin contact area due to fingertip force exertion”, Journal of Tezukayama College. Cultural and social sciences & natural sciences 31 213_a-204_a, 1994 Mar. 1) describes that when a person presses a target location with a finger, a contact area between the finger and the target location changes exponentially according to a force of a fingertip, regardless of age or gender. Accordingly, it is believed that the contact area between the finger and the target location increases at a predetermined rate until the finger exerts a predetermined force, and that this increase in contact area at the predetermined rate is the same for all five fingers.

Therefore, the inventor of the present application has considered to determine an operation state of a switch unit of an operating panel of a user from an increase rate of a contact area, and has devised a method for determining the operation state when the contact area of a contact starting point at which the finger comes into contact with the switch unit is a reference value and the contact area becomes a predetermined multiple of the reference value.

### SUMMARY OF INVENTION

However, the contact area between the finger and the switch unit greatly varies depending on a size of the finger operating the switch unit or a touch method such as which part of the finger is used for operating the switch unit. For this reason, it has been difficult to accurately identify the contact starting point of the finger based on the contact area between the finger and the switch unit.

The present invention has been made in view of the above problems, and an object of the present invention is to enable improved accuracy in acquiring a contact starting point of a finger, regardless of a size of the finger or a touch method of the finger.

According to an aspect of the present invention, an operating panel includes: a panel member; a switch unit provided on the panel member and configured to be pressed by a user; a sensor unit configured to detect a capacitance that changes according to a positional relationship between a finger of the user and the switch unit; and a control unit configured to receive the capacitance detected by the sensor unit, wherein the control unit determines a contact starting point at which the finger of the user comes into contact with the switch unit based on an inflection point appearing in a change waveform of the received capacitance, and determines, when the capacitance further increases from the contact starting point and exceeds a predetermined value, an operation state in which the switch unit is being operated.

In the above aspect, the capacitance that changes according to the positional relationship between the finger of the user and the switch unit changes inversely proportional to a distance from the finger to the switch unit while the finger is away from the switch unit. Therefore, a rate of increase in the capacitance increases as the finger approaches the switch unit.

On the other hand, the capacitance that changes according to the positional relationship between the finger of the user and the switch unit changes in proportion to a contact area between the finger and the switch unit while the finger is in contact with the switch unit. Further, the contact area between the finger and the switch unit increases in proportion to a pressing force of the finger pressing the switch unit.

Therefore, in the change waveform of the capacitance received from the sensor unit by the control unit, the inflection point appears between a region where the finger approaches the switch unit and a region where the finger is in contact with the switch unit and applies the pressing force to the switch unit.

Therefore, the control unit determines the contact starting point at which the finger of the user comes into contact with the switch unit based on the inflection point appearing in the change waveform of the capacitance. Therefore, it is possible to improve accuracy of acquiring the contact starting point of the finger without being affected by a size of the operating finger or a touch method of the finger.

Further, the control unit uses the contact starting point determined without being affected by the size of the operating finger or the touch method of the finger as a reference, and determines an operation state in which the switch unit is being operated when the capacitance further increases from the contact starting point and exceeds the predetermined value. Therefore, compared to a case in which the capacitance of the contact starting point, which lacks accuracy, is used as the reference value and the switch unit is determined to be operated based on an amount of increase in the capacitance from this reference value, it is possible to accurately detect the operation of the switch unit regardless of the size or the touch method of the finger.

### BRIEF DESCRIPTION OF DRAWINGS

FIG. 1 is a perspective view illustrating a configuration of an interior component for a vehicle to which an operating panel according to an embodiment of the present invention is applied.

FIG. 2 is an exploded perspective view of the operating panel.

FIG. 3 is a cross-sectional view illustrating a configuration of a touch position sensor.

FIG. 4 is a diagram showing a change in capacitance when a switch unit is operated with a finger, a first-order differential waveform, and a second-order differential waveform.

FIG. 5 is a flowchart related to switch determination control.

FIG. 6 is a flowchart related to switch determination control of an operating panel according to a modification.

### DESCRIPTION OF EMBODIMENTS

Hereinafter, an operating panel 2 and an instrument panel 1 serving as an interior component for a vehicle to which the operating panel 2 is applied according to an embodiment of the present invention will be described with reference to the drawings.

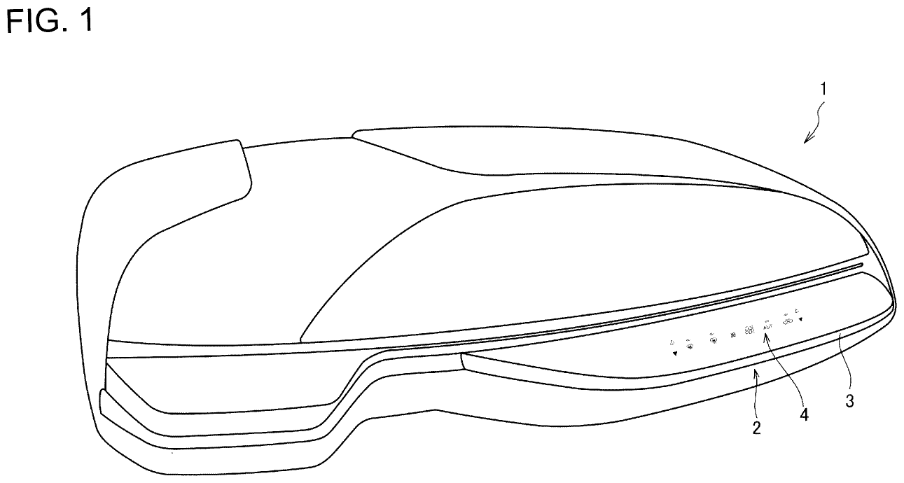

First, the instrument panel 1 will be described with reference to FIG. 1. FIG. 1 is a perspective view illustrating a configuration of the instrument panel 1.

As illustrated in FIG. 1, the instrument panel 1 includes the operating panel 2. The instrument panel 1 is provided in a passenger compartment of the vehicle. The instrument panel 1 is provided in front of the passenger compartment including a front face of a driver seat. An instrument (not illustrated) indicating information on an automobile is disposed on the instrument panel 1.

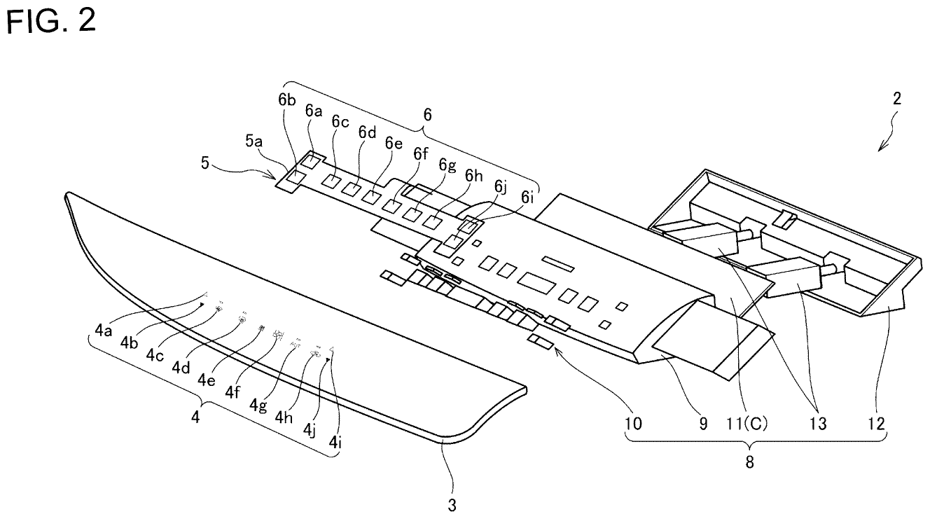

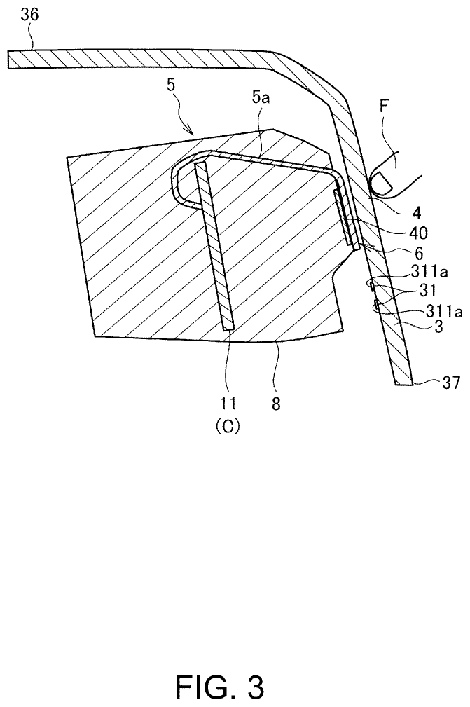

Next, the operating panel 2 will be described with reference to FIGS. 2 and 3.

FIG. 2 is an exploded perspective view of the operating panel 2. FIG. 3 is a cross-sectional view illustrating a configuration of a touch position sensor 6.

As illustrated in FIG. 2, the operating panel 2 includes a panel member 3, a sensor module 5, and a main body 8.

The panel member 3 is formed in a free curved surface shape in which at least a part is curved. The panel member 3 is exposed to the passenger compartment of the vehicle. The panel member 3 includes a switch 4 serving as a switch unit.

The switch 4 is provided as a part of the panel member 3. The switch 4 is pressed by a user. The switch 4 includes first to tenth switches 4a to 4j for operating an air conditioner.

The first switch 4a, the second switch 4b, the ninth switch 4i, and the tenth switch 4j are switches for adjusting a temperature of the air conditioner. The third switch 4c is a switch for switching ON/OFF of a rear defogger. The fourth switch 4d is a switch for switching ON/OFF of a front defroster. The fifth switch 4e and the sixth switch 4f are switches for adjusting an air volume of the air conditioner. The seventh switch 4g is a switch for switching ON/OFF of an auto mode. The eighth switch 4h is a switch for switching between inside and outside air.

As illustrated in FIG. 2, the sensor module 5 includes a sensor sheet 5a and the touch position sensor 6.

As illustrated in FIG. 3, the sensor sheet 5a is connected to a substrate portion 11 (controller C) serving as a control unit. The sensor sheet 5a electrically connects the touch position sensor 6 and the substrate portion 11.

The controller C constituting the control unit is constituted by a CPU as a processor. The controller C operates in accordance with a program read from, for example, a memory (not illustrated) provided in the substrate portion 11 to perform switch determination control to be described later.

The touch position sensor 6 is provided on the sensor sheet 5a so as to face a back surface of the panel member 3. The touch position sensor 6 is provided corresponding to each switch 4. The touch position sensor 6 detects that a finger F of the user touches each switch 4. That is, a first touch position sensor 6a to a tenth touch position sensor 6j are provided at positions corresponding to the first switch 4a to the tenth switch 4j, respectively.

As illustrated in FIG. 3, the touch position sensor 6 is provided on the back surface of the panel member 3 so as to correspond to each switch 4. The touch position sensor 6 is a capacitance proximity sensor. The touch position sensor 6 includes a plate-shaped electrode 40 disposed on the sensor sheet 5a.

The touch position sensor 6 measures a capacitance (capacitance value) at a cycle of, for example, 10 [ms]. The touch position sensor 6 detects the capacitance that changes according to a positional relationship between the finger F of the user and the switch 4 that is the switch unit.

When the finger F of the user approaches the switch 4, the capacitance measured by the touch position sensor 6 changes according to a distance from the finger F of the user to the switch 4. Further, when the finger F of the user is in contact with the switch 4, the capacitance measured by the touch position sensor 6 changes according to a contact area of the finger F of the user.

The capacitance detected by the touch position sensor 6 is transmitted as an electrical signal to the controller C (substrate portion 11). The controller C (substrate portion 11) determines which switch 4 the finger F of the user touches based on the electrical signal transmitted from the touch position sensor 6.

As illustrated in FIG. 2, the main body 8 includes a base portion 9, illumination portions 10, the substrate portion 11, a case portion 12, and a pair of solenoids 13 serving as a vibration generation device.

The base portion 9 is attached to a vehicle body. A plurality of through holes for embedding the illumination portions 10 are formed in the base portion 9.

The illumination portions 10 are transparent members that allow light to pass through. A plurality of illumination portions 10 are provided corresponding to the first switch 4a to the tenth switch 4j. The illumination portions 10 transmit light that illuminates the first switch 4a to the tenth switch 4j from a back surface.

The substrate portion 11 is provided between the base portion 9 and the case portion 12. The electrical signal from the touch position sensor 6 is input to the substrate portion 11. The substrate portion 11 outputs an electrical signal corresponding to the input electrical signal to the controller C. A plurality of light emitting portions (not illustrated) that illuminate the illumination portions 10 are mounted on the substrate portion 11. Each of the light emitting portions includes, for example, a light emitting diode (LED).

The case portion 12 is inserted into a back side of the base portion 9 and is attached to the vehicle body. The case portion 12 holds one end of the solenoid 13.

As illustrated in FIG. 2, the solenoid 13 is disposed on a back surface side of the panel member 3. The solenoid 13 generates a tactile sensation to the finger F of the user by vibrating the panel member 3 when the switch 4 is operated. The solenoid 13 includes a coil (not illustrated) and a movable iron core (not illustrated).

When the coil is energized, the solenoid 13 displaces the movable iron core toward the panel member 3. On the other hand, when the energization of the coil is stopped, the solenoid 13 separates the movable iron core from the panel member 3. Accordingly, the solenoid 13 generates vibration in the panel member 3.

The one end of the solenoid 13 is held by the case portion 12. Accordingly, the vibration generated by the displacement of the movable iron core can be reliably transmitted to the panel member 3.

In the operating panel 2 configured as described above, the capacitance measured by the touch position sensor 6 changes according to the positional relationship between the finger F of the user and the switch 4. The controller C determines whether the switch 4 is in an operation state or a non-operation state based on the change in the capacitance.

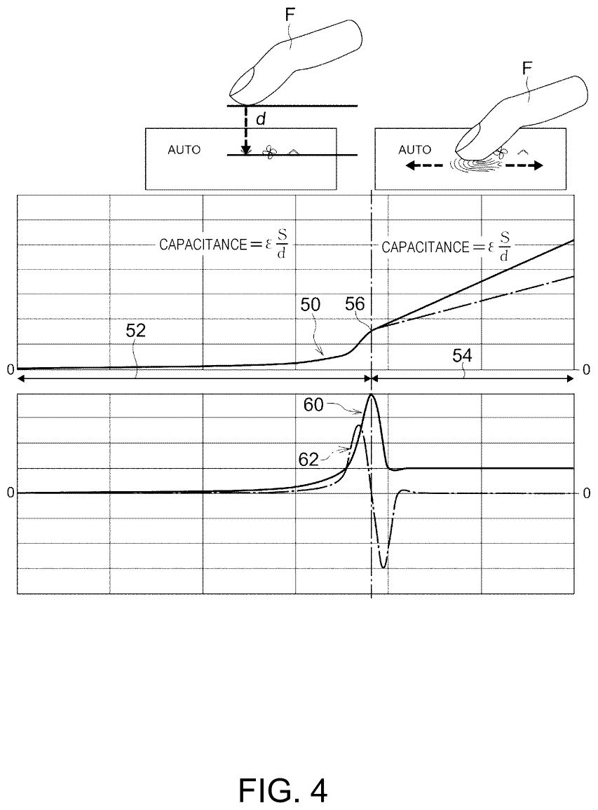

Next, a relationship between the positional relationship between the finger F of the user and the switch 4, and the capacitance detected by the touch position sensor 6 will be described with reference to FIG. 4. FIG. 4 is a diagram showing the change in the capacitance when the switch 4 serving as the switch unit is operated with the finger F, a first-order differential waveform 60, and a second-order differential waveform 62.

As illustrated in FIG. 4, the capacitance detected by the touch position sensor 6 is expressed by the following (Formula 1).

$$Capacitance = ε ( S / d ) \qquad ( Formula 1 )$$

In the Formula 1, ε represents a permittivity of the panel member 3 covering the touch position sensor 6. S indicates the contact area between the finger F of the user and the switch 4 of the panel member 3. d indicates a distance from the finger F of the user to the electrode 40 of the touch position sensor 6 provided on the switch 4 of the panel member 3 (hereinafter, described as a distance d from the finger F to the switch 4).

When the finger F is separated from the switch 4, the capacitance changes inversely proportional to the distance d from the finger F to the switch 4. Therefore, the capacitance increases as the finger F approaches the switch 4, and a rate of increase also increases.

On the other hand, when the finger F is in contact with the switch 4, the capacitance changes in proportion to the contact area S between the finger F and the switch 4. The contact area S between the finger F and the switch 4 increases as the finger F is crushed by a force of pressing the switch 4. The contact area S increases in proportion to the pressing force of the finger F pressing the switch 4.

In an operation in which the user presses the switch 4 with the finger F, an inflection point 56 occurs in a change waveform 50 of the capacitance which changes over time between a region 52 just before the finger F comes into contact with the switch 4 and a region 54 where the finger F that has come into contact with the switch 4 applies the pressing force to the switch 4.

FIG. 4 also shows the first-order differential waveform 60 and the second-order differential waveform 62 corresponding to the change waveform 50. The first-order differential waveform 60 indicates a change in a value obtained by first-order differentiation of an amount of change in the capacitance detected by the touch position sensor 6 with respect to a time. The second-order differential waveform 62 indicates a change in a value obtained by second-order differentiation of the amount of change in the capacitance detected by the touch position sensor 6 with respect to the time.

The first-order differential waveform 60 reaches a maximum at the inflection point 56 of the change waveform 50 and then starts to decrease at the inflection point 56. Therefore, the controller C can determine that the inflection point 56 appears when the value obtained by the first-order differentiation of the amount of change in the capacitance detected by the touch position sensor 6 with respect to the time starts to decrease.

The second-order differential waveform 62 becomes “0” at a maximum or minimum value of the first-order differential waveform 60. Therefore, the controller C can determine that the inflection point 56 appears when the value obtained by the first-order differentiation of the amount of change in the capacitance detected by the touch position sensor 6 with respect to the time is a positive value and the value obtained by the second-order differentiation of the amount of change in the capacitance with respect to the time is equal to or less than “0”.

Here, the change waveform 50 is expressed by a function (formula) that is determined based on a measured value of the capacitance measured by the touch position sensor 6 at a predetermined cycle (for example, a cycle of 10 [ms]). Examples of a method used for obtaining this function include a least squares method, averaging of measured values, and a difference scheme.

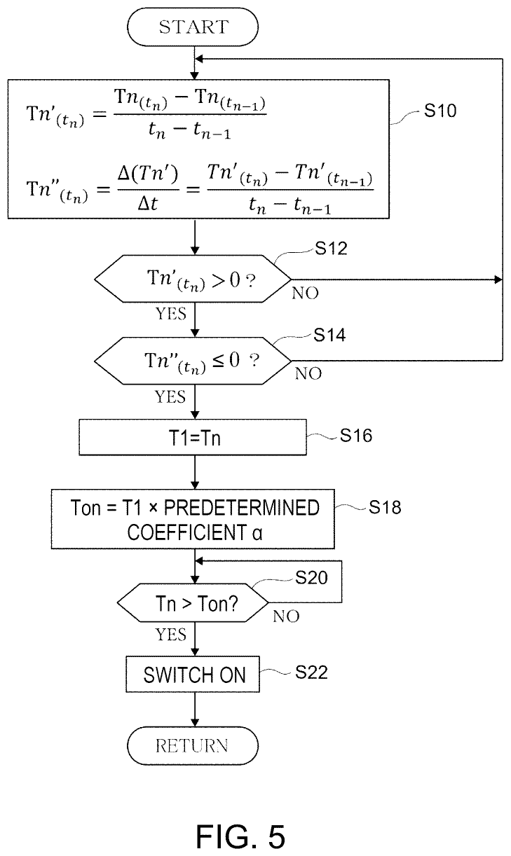

Next, control related to determination of the operation state of the switch 4 (hereinafter, also referred to as the “switch determination control”) will be described with reference to a flowchart shown in FIG. 5. FIG. 5 is the flowchart related to the switch determination control.

First, symbols used in the flowchart will be described.

Tn is a Diff value calculated based on the capacitance measured by the touch position sensor 6 at the predetermined cycle.

The Diff value has a relationship “Diff value=Rawcount value−Baseline value”.

The Rawcount value indicates the capacitance (capacitance value) obtained from the touch position sensor 6. The Rawcount value is a value that increases as the finger F comes into contact with the switch 4 and the capacitance increases. The Baseline value indicates an average value of the Rawcount value when the finger F is not in contact with the switch 4. The Baseline value is a reference value for acquiring the Diff value.

Tn changes at the predetermined cycle (for example, a cycle of 10 [ms]). Tn shown in each step of the flowchart indicates the Diff value calculated based on the capacitance measured when the step is executed.

tn indicates a cycle timing for periodically acquiring the capacitance from the touch position sensor 6. Tn′ indicates a value obtained by first-order differentiation of an amount of change in the Diff value Tn with respect to the time. Tn″ indicates a value obtained by second-order differentiation of the amount of change in the Diff value Tn with respect to the time.

Next, the switch determination control will be described.

When the controller C operates according to a switch determination program read from the memory, the controller C calls a switch determination control process from a main routine and executes the switch determination control process.

In the switch determination control process, the controller C calculates the value Tn′(tₙ) obtained by the first-order differentiation of the amount of change in the Diff value Tn with respect to the time, and the value Tn″(tₙ) obtained by the second-order differentiation of the amount of change in the Diff value Tn with respect to the time (step S10).

Specifically, the controller C divides the amount of change in the capacitance {Tn(tₙ)−Tn(tₙ₋₁)} obtained in a time (tₙ−tₙ₋₁) within a predetermined period of time by the time (tₙ−tₙ₋₁) to obtain the value Tn′(tₙ) obtained by the first-order differentiation of the amount of change in the Diff value Tn with respect to the time.

The controller C divides the amount of change {Tn′(tₙ)−Tn′(tₙ₋₁)} in the value Tn′(tₙ) obtained by the first-order differentiation by the time (tₙ−tₙ₋₁) to obtain the value Tn″(tₙ) obtained by the second-order differentiation of the amount of change in the Diff value Tn with respect to the time.

Further, the controller C determines whether the value Tn′(tₙ) obtained by first-order differentiation of the change waveform 50 is more than “0” (step S12). When it is determined in step S12 that the first-order differential value Tn′(tₙ) is equal to or less than “0”, the controller C repeats steps S10 and S12 until the first-order differential value Tn′(tₙ) exceeds “0”. During this time, the controller C constantly reads new Tn, Tn′, and Tn″.

In step S12, when the value Tn′(tₙ) obtained by the first-order differentiation exceeds “0”, the capacitance increases, and the finger F approaches the switch 4. Therefore, the controller C determines whether the value Tn″(tₙ) obtained by the second differentiation is equal to or less than “0” (step S14).

In step S14, when the value Tn″(tₙ) obtained by the second differentiation exceeds “0”, the controller C repeats steps S10 to S14 until the value Tn″(tₙ) obtained by the second-order differentiation becomes “0” or less. During this time, the controller C also constantly reads the new Tn, Tn′, and Tn″.

In step S14, when the controller C determines that the value Tn″(tₙ) obtained by the second differentiation is equal to or less than “0”, the controller C can determine that the second-order differential waveform 62 passes through “0” and the inflection point 56 appears in the change waveform 50. Since the controller C can determine that the finger F has come into contact with the switch 4 based on the inflection point 56, this point is determined as the contact starting point.

In this way, the controller C obtains the inflection point 56 from a temporal change of the Diff value Tn indicating a value of the change waveform 50, and determines the contact starting point at which the finger F of the user comes into contact with the switch 4 based on the inflection point 56.

Here, in the present embodiment, although a case will be described in which a comparison value to be compared with the value Tn″(tₙ) obtained by the second-order differentiation is “0”, the present embodiment does not limit the comparison value to “0”. For example, the comparison value to be compared with the value Tn″(tₙ) obtained by the second-order differentiation may have a certain width. Further, the comparison value may be a value shifted a predetermined amount toward a positive or negative side from “0”.

Further, the controller C sets the latest Diff value Tn at the contact starting point as a reference value T1 (step S16), and multiplies this reference value T1 by a predetermined coefficient α to set an ON threshold value Ton (step S18). The predetermined coefficient α by which the reference value T1 is multiplied is, for example, 1.4.

Next, The controller C waits until the latest Diff value Tn exceeds the ON threshold value Ton (step S20). During this time, the controller C also constantly reads the new Tn, Tn′, and Tn″. When the latest Diff value Tn exceeds the ON threshold value Ton in step S20, the controller C determines that the switch 4 is in the operation state (step S22), and returns to the main routine. The fact that the switch 4 is in the operation state is stored, for example, in an operation state flag secured in a memory, and is used in other routines.

Accordingly, when the capacitance further increases from the contact starting point and exceeds the ON threshold value Ton which is a predetermined value, the controller C determines that the pressing force of the switch 4 exceeds a predetermined value and the operation state in which the switch 4 is being operated.

In the present embodiment, when the pressing force of the finger F pressing the switch 4 reaches, for example, 4.5 N, the operation state is determined.

Here, it is known that regardless of whether the switch 4 is pressed with a pulp, a side, or a tip of the finger F, the pressing force of the switch 4 becomes 4.5 N or more when the Diff value Tn becomes 1.4 times or more the Diff value Tn at the contact starting point. For this reason, it is desirable that the predetermined coefficient α by which the reference value T1 is multiplied in step S18 be 1.4 or more.

### Function and Effect

According to the above embodiment, the following effects are achieved.

The operating panel 2 includes the panel member 3 and the switch 4 provided on the panel member 3 and serving as the switch unit that is pressed by the user. The operating panel 2 includes the touch position sensor 6 as a sensor unit that detects the capacitance that changes depending on the positional relationship between the finger F of the user and the switch 4, and the controller C as the control unit that receives the capacitance (Diff value Tn) detected by the touch position sensor 6. The controller C determines the contact starting point at which the finger F of the user comes into contact with the switch 4 based on the inflection point 56 that appears in the change waveform 50 of the received capacitance (Diff value Tn). Further, the controller C determines the operation state in which the switch 4 is being operated when the capacitance (Diff value Tn) further increases from the contact starting point and exceeds the predetermined value (ON threshold value Ton).

In the operating panel 2 having this configuration, the change waveform 50 of the capacitance received from the touch position sensor 6 by the controller C has the inflection point 56 between the region 52 in which the finger F approaches the switch 4 and the region 54 in which the finger F comes into contact with the switch 4 and applies the pressing force to the switch 4.

Therefore, the controller C obtains the inflection point 56 from the temporal change of the Diff value Tn indicating the value of the change waveform 50, and determines the contact starting point at which the finger F of the user comes into contact with the switch 4 based on the inflection point 56. Accordingly, it is possible to improve accuracy of acquiring the contact starting point of the finger F without being affected by a size of the operating finger F or a touch method of the finger F.

The controller C sets the Diff value Tn according to the capacitance of the determined contact starting point as the reference value, without being affected by the size of the operating finger F or the touch method of the finger F. Further, when the Diff value Tn of the reference value further increases and exceeds the ON threshold value Ton as the predetermined value, the controller C determines the operation state in which the switch 4 is being operated.

Therefore, compared to a case in which the capacitance of the contact starting point, which lacks accuracy, is used as the reference value and the switch 4 is determined to be operated based on an amount of increase in the capacitance from this reference value, it is possible to accurately detect the operation of the switch 4 regardless of the size or the touch method of the finger F.

In the operating panel 2, the controller C as the control unit determines that the inflection point 56 appears when the value obtained by the first-order differentiation of the amount of change in the received capacitance (Diff value Tn) with respect to the time is the positive value and the value obtained by the second-order differentiation of the amount of change with respect to the time is equal to or less than “0”.

According to this configuration, by using the value obtained by the first-order differentiation and the value obtained by the second-order differentiation of the amount of change in the capacitance (Diff value Tn) with respect to the time, it is possible to identify the inflection point 56 that appears in the change waveform 50. Accordingly, it is easy to determine the inflection point 56 through calculation processing of the controller C.

In the operating panel 2, the ON threshold value Ton as the predetermined value is set by multiplying the capacitance obtained at the contact starting point by the predetermined coefficient α.

According to this configuration, the ON threshold value Ton as the predetermined value can be calculated easily, and a load of the control can be prevented from increasing.

The ON threshold value Ton for determining the operation state of the switch 4 is calculated based on the capacitance (Diff value Tn) obtained at the contact starting point. Accordingly, since the ON threshold value Ton can be determined based on the capacitance of the contact starting point, which can vary depending on the size or the touch method of the finger F, it is possible to set an appropriate ON threshold value Ton according to the size or the touch method of the finger F, compared to a case in which the ON threshold value Ton is set to a fixed value.

In the present embodiment, although the case has been described in which the operation state of the switch 4 is determined based on the latest Diff value Tn corresponding to a magnitude of the capacitance, the present embodiment is not limited to this. For example, the operation state may be determined based on the contact area between the finger F and the switch 4, which is correlated with the capacitance and changes depending on the magnitude of the capacitance.

Specifically, the controller C calculates the contact area between the finger F of the user and the switch 4 from the latest Diff value Tn acquired in the above-mentioned step S16, and sets the calculated contact area as the reference value T1. A formula for calculating the contact area from the Diff value Tn is determined in advance by experiments or the like.

Further, the controller C multiplies the reference value T1 by the predetermined coefficient α to set the ON threshold value Ton, which is the predetermined threshold value (step S18). Furthermore, when the contact area calculated based on the latest Diff value Tn exceeds the ON threshold value Ton (step S20), the controller C determines that the switch 4 is in the operation state (step S22).

In the operating panel 2, the controller C as the control unit calculates the contact area between the finger F of the user and the switch 4 as the switch unit based on the received capacitance. Further, the controller C determines that the capacitance (Diff value Tn) has exceeded the predetermined value when the contact area exceeds the ON threshold value Ton as the predetermined threshold value.

With such a configuration, the same function and effect as those described above can be obtained.

In the operating panel 2, the ON threshold value Ton as the predetermined threshold value is set by multiplying the contact area obtained at the contact starting point by the predetermined coefficient α.

According to this configuration, the ON threshold value Ton as the predetermined threshold value can be calculated easily, and the load of the control can be prevented from increasing.

The ON threshold value Ton for determining the operation state of the switch 4 is calculated based on the contact area obtained at the contact starting point. Accordingly, since the ON threshold value Ton can be determined based on the contact area at the contact starting point, which can vary depending on the size or the touch method of the finger F, it is possible to set an appropriate ON threshold value Ton according to the size or the touch method of the finger F, compared to the case in which the ON threshold value Ton is set to the fixed value.

### <Modification>

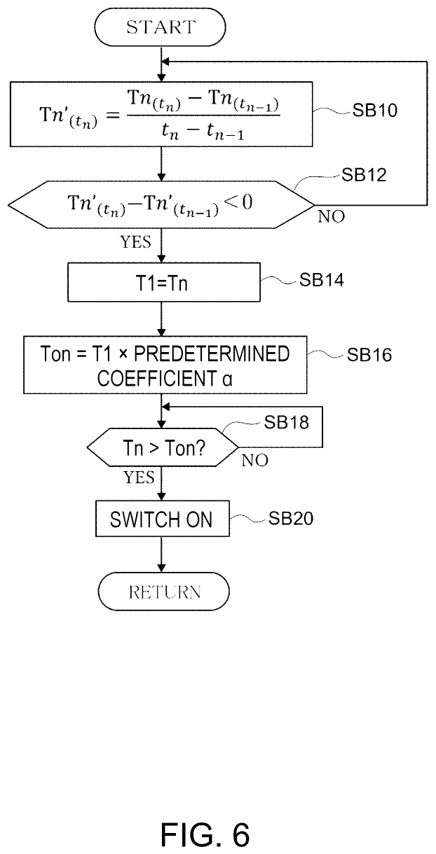

FIG. 6 is a flowchart related to switch determination control of an operating panel according to a modification.

Since the operating panel 2 according to the modification is different from the embodiment described above in the switch determination control process executed by the controller C, which is a control unit, the following description will focus on the difference from the switch determination control process described above.

When the controller C executes the switch determination control process, the controller C calculates the value Tn′(tₙ) obtained by first-order differentiation of an amount of change in a received capacitance (Diff value Tn) with respect to a time in the same manner as described above (step SB10).

The controller C determines whether a subtraction value obtained by subtracting, from the value Tn′(tₙ) obtained by the most recent first-order differentiation, the value Tn′(tₙ₋₁) obtained by the first-order differentiation performed immediately before that is less than “0” (step SB12). When the subtraction value is equal to or more than “0” in step SB12, steps SB10 and SB12 are repeated until the subtraction value becomes less than “0”. During this time, the controller C also constantly reads new Tn, Tn′, and Tn″.

In step SB12, when the subtraction value is less than “0”, the controller C can determine that the value obtained by the first-order differentiation turns to decrease and the inflection point 56 appears in the change waveform 50. Since the controller C can determine that the finger F has come into contact with the switch 4 based on the inflection point 56, this point is determined as a contact starting point.

In this way, the controller C obtains the inflection point 56 from a temporal change of the Diff value Tn indicating a value of the change waveform 50, and determines the contact starting point at which the finger F of the user comes into contact with the switch 4 based on the inflection point 56.

Then, the controller C sets the latest Diff value Tn at the contact starting point as the reference value T1 (step SB14), and multiplies this reference value T1 by the predetermined coefficient α to set an ON threshold value Ton (step SB16).

Next, the controller C waits until the latest Diff value Tn exceeds the ON threshold value Ton (step SB18). In step SB18, when the latest Diff value Tn exceeds the ON threshold value Ton, the controller C determines that the switch 4 is in the operation state (step SB20), and returns to the main routine. Accordingly, the controller C determines the operation state in which the switch 4 is being operated when the capacitance (Diff value Tn) further increases from the contact starting point and exceeds the ON threshold value Ton, which is the predetermined value.

### Function and Effect

In the operating panel 2, the controller C as the control unit determines that the inflection point 56 appears when the value obtained by the first-order differentiation of the amount of change in the received capacitance (Diff value Tn) with respect to the time starts to decrease.

According to this configuration, by using the value obtained by the first-order differentiation of the amount of change in the received capacitance (Diff value Tn) with respect to the time, it is possible to determine that the inflection point 56 appears in the change waveform 50, and the contact starting point at which the finger F comes into contact with the switch 4 can be identified.

Therefore, compared to a case in which the contact starting point is identified using the value obtained by the first-order differentiation and the value obtained by the second-order differentiation of the amount of change in the received capacitance (Diff value Tn) with respect to the time, calculation processing can be simplified and a calculation speed can be improved.

In the present embodiment, although the case has been described in which the operation state of the switch 4 is determined based on the latest Diff value Tn corresponding to a magnitude of the capacitance, the present embodiment is not limited to this. For example, the operation state may be determined based on the contact area between the finger F and the switch 4, which is correlated with the capacitance and changes depending on the magnitude of the capacitance.

Specifically, the controller C calculates the contact area between the finger F of the user and the switch 4 from the latest Diff value Tn acquired in the above-mentioned step SB14, and sets the calculated contact area as the reference value T1. A formula for calculating the contact area from the Diff value Tn is determined in advance by experiments or the like.

Further, the controller C multiplies the reference value T1 by the predetermined coefficient α to set the ON threshold value Ton, which is a predetermined threshold value (step SB16).

Next, when the contact area calculated from the latest Diff value Tn exceeds the ON threshold value Ton (step SB18), the controller C determines that the switch 4 is in the operation state (step SB20).

In the operating panel 2, the controller C as the control unit calculates the contact area between the finger F of the user and the switch 4 as the switch unit based on the received capacitance, and determines that the capacitance has exceeded the predetermined value when the contact area exceeds the predetermined threshold value.

With such a configuration, the same function and effect as those of the above-described embodiment can be obtained.

Although the embodiment of the present invention has been described in the above, the above-mentioned embodiment merely illustrates a part of application examples of the present invention, and the technical scope of the present invention is not intended to be limited to the specific configurations of the above-described embodiment.

In the above embodiment, an example is shown in which the switch 4 is a switch for operating the air conditioner. However, the switch 4 may be a switch for operating a car audio, or may be a switch for another operation.

In the above embodiment, an example in which ten switches 4 are provided has been described. However, the number of the switches 4 is not limited to the aspect.

In the above embodiment, an example is shown in which the present invention is applied to the operating panel 2 provided in the instrument panel 1. However, the present invention can be applied to an input device provided in a console or an arm rest. The present invention can be applied to an operating panel provided in various devices.

The present application claims a priority based on Japanese Patent Application No. 2022-127663 filed with the Japan Patent Office on Aug. 10, 2022, the entire content of which are incorporated into this specification by reference.

1. An operating panel comprising:
a panel member;
a switch unit provided on the panel member and configured to be pressed by a user;
a sensor unit configured to detect a capacitance that changes according to a positional relationship between a finger of the user and the switch unit; and
a control unit configured to receive the capacitance detected by the sensor unit, wherein
the control unit
determines a contact starting point at which the finger of the user comes into contact with the switch unit based on an inflection point appearing in a change waveform of the received capacitance, and
determines, when the capacitance further increases from the contact starting point and exceeds a predetermined value, an operation state in which the switch unit is being operated.

2. The operating panel according to claim 1, wherein the control unit determines that the inflection point appears when a value obtained by first-order differentiation of an amount of change in the received capacitance with respect to a time starts to decrease.

3. The operating panel according to claim 1, wherein the control unit determines that the inflection point appears when a value obtained by first-order differentiation of an amount of change in the received capacitance with respect to a time is a positive value and a value obtained by second-order differentiation of the amount of change with respect to the time is 0 or less.

4. The operating panel according to claim 1, wherein the predetermined value is set by multiplying the capacitance obtained at the contact starting point by a predetermined coefficient.

5. The operating panel according to claim 1, wherein the control unit calculates a contact area between the finger of the user and the switch unit based on the received capacitance, and determines that the capacitance exceeds the predetermined value when the contact area exceeds a predetermined threshold value.

6. The operating panel according to claim 5, wherein the predetermined threshold value is set by multiplying the contact area obtained at the contact starting point by a predetermined coefficient.
